(19) United States
(12) Patent Application Publication
(10) Pub. No.: US 2020/0356062 A1
(43) Pub. Date: Nov. 12, 2020

(54) AN ENERGY CONSERVING TIME DISPLAY DEVICE AND A METHOD THEREOF

(71) Applicant: KAHA PTE. LTD., Singapore (SG)

(72) Inventor: SUDHEENDRA SHANTHARAM, Bengaluru (IN)

(73) Assignee: KAHA PTE. LTD., Singapore (SG)

(21) Appl. No.: 16/960,341

(22) PCT Filed: Dec. 26, 2018
(86) PCT No.: PCT/SG2018/000012

§ 371 Date: Jul. 7, 2020

(30) Foreign Application Priority Data
Jan. 8, 2018 (IN) 201841000785

(51) Int. Cl. G04C 9/00; G04C 3/00; G04G 19/12

(52) U.S. Cl. CPC G04C 9/00; G04G 19/12; G04C 3/00

(57) ABSTRACT

An energy conserving time display device and a method thereof. The present invention discloses an energy saving time display device and a method for energy conservation. The energy saving time display device includes an hour hand and a minute hand for indicating the time, at least one micro motor for driving the hour hand and the minute hand to characterize the time, a scheduler coupled to the micro motor to schedule the movement of the hour hand and the minute hand, a time observance unit configured to keep track of the current time and an actuator coupled to the micro motor to actuate the micro motor from a first state to a second state. The method includes the step of scheduling a schedule of the first state and the second state of the micro motor by the scheduler and executing the schedule set by the scheduler. The micro motor is configured to function for a user specified period of time.

### FIELD OF THE INVENTION

The present invention relates to the field of time display device. In particular, the invention relates to an energy saving time display device and a method thereof.

### BACKGROUND OF THE INVENTION

Most of the existing time display devices utilize the quartz mechanism for representing the time accurately. Of late, there are time display devices available with motors. Such time display devices must be of sufficient energy to drive the seconds hand, the minute hand, the hour hand and other auxiliary mechanisms, such as the calendar. Even though the energy consumption of such time display device is low, the time display device requires comparatively large amount of energy for driving the hands especially the second hand which needs to be driven at every second. In some of the available time display devices the motion of the seconds hand is stopped in order to conserve the energy when the time display device is functioning in an economical mode. The functioning of the seconds hand resumes once the economical mode is turned off.

One of the U.S. Pat. No. 4,744,067 discloses an analog electronic watch. The analog electronic watch disclosed is a multi-motorized watch, which stops the second hand when light becomes dim to saves battery life. A memory circuit is synchronized with the minute hand so that whenever the ambient light becomes sufficiently strong, the current time is displayed. However, the analog electronic watch needs an additional light sensor and the watch functions continuously in the presence of a light source.

Hence, there is a need to optimize the electrical energy consumption of the time display device.

### SUMMARY OF THE INVENTION

In one embodiment of the present invention, an energy saving time display device is disclosed. The energy saving time display device includes an hour hand and a minute hand for indicating the time; at least one micro motor for driving the hour hand and the minute hand to characterize the time; a scheduler coupled to the micro motor to schedule the movement of the hour hand and the minute hand; a time observance unit configured to keep track of the current time; and an actuator coupled to the micro motor to actuate the micro motor from a first state to a second state.

According to another embodiment of the present invention, the hour hand and the minute hand of the energy saving time display device is coupled to a gear mechanism, wherein the gear mechanism is configured to drive the hour hand and the minute hand to represent the time.

According to another embodiment of the present invention, the energy saving time display device comprises at least two micro motors for driving the hour hand and the minute hand respectively to represent the time. In yet another embodiment of the present invention, the time observance unit comprises a real-time clock. In another embodiment of the present invention, the energy saving time display device is at least one of a motorized clock, timepiece or a wristwatch or a smart watch. In yet another embodiment of the present invention, the time display wristwatch is an analog wristwatch.

According to another embodiment, the present invention discloses a method for energy conservation of an energy saving time display device. The energy saving time display device includes an hour hand and a minute hand for indicating the time; at least one micro motor for driving the hour hand and the minute hand to characterize the time; a scheduler coupled to the micro motor to schedule the movement of the hour hand and the minute hand; a time observance unit configured to keep track of the current time; and an actuator coupled to the micro motor to actuate the micro motor from a first state to a second state. The method of energy conservation of the energy saving time display device includes the steps of scheduling a schedule of the first state and the second state of the micro motor by the scheduler and the step of executing the schedule set by the scheduler. The micro motor is configured to function for a user specified period of time to drive the hour hand and the minute hand.

According to another embodiment of the energy saving time display, the micro motor is capable of activating plurality of states, but not limited to first state, second state etc. In another embodiment of the present invention, the user may set the duration of the first state and the second state. Here the micro motor works for a user specified period to drive the hour hand and the minute hand. In yet another embodiment of the present invention the method further includes the step of actuating the micro motor to actuate the hour hand and the minute hand to represent the current time.

### BRIEF DESCRIPTION OF THE DRAWINGS

The foregoing and other features of embodiments of the present invention, will become more apparent from the following detailed description of embodiments when read in conjunction with the accompanying drawings. In the drawings, like reference numerals refer to like elements.

FIG. 1: illustrates a block diagram of the energy saving time display device, in accordance with an embodiment of the present invention.

FIG. 2: illustrates the flow chart for the method for energy conservation of an energy saving time display device, in accordance with an embodiment of the present invention.

### DETAILED DESCRIPTION

In the following detailed description, reference is made to the accompanying drawings that form a part hereof, and in which shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. The singular forms “a,” “an,” and “the” include plural references unless the context clearly dictates otherwise. The following detailed description is, therefore, not be taken as limiting the scope of the invention, but instead the invention is to be defined by the appended claims.

The present invention provides an energy saving time display device and a method thereof, which overcomes the energy issues present in existing time display devices. In one embodiment of the present invention, the energy saving time display device includes at least an hour hand and a minute hand for indicating the time. The energy saving time display device also includes at least one micro motor for driving the hour hand and the minute hand to characterize the time and a scheduler coupled to the micro motor to schedule the movement of the hour hand and the minute hand. The energy saving time display device further includes a time observance unit configured to keep track of the current time and an actuator coupled to the micro motor to actuate the micro motor from a first state to a second state.

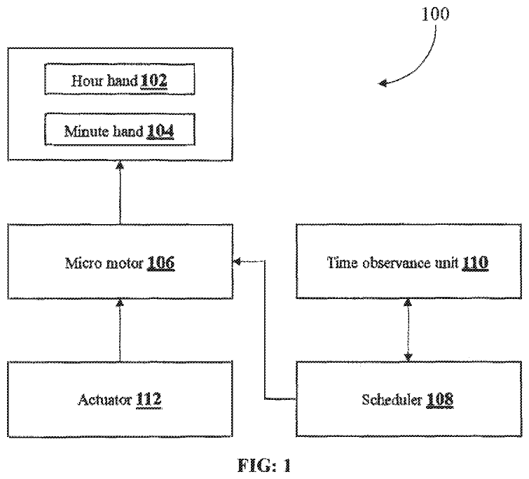

FIG. 1 illustrates the block diagram of an energy saving time display device, in accordance with an embodiment of the present invention. The energy saving time display device (100) comprises an hour hand (102) and a minute hand (104) for indicating the time. The energy saving time display device (100) includes at least one micro motor (106) for driving the hour hand (102) and the minute hand (104) to characterize the time. The energy saving time display device (100) also includes a scheduler (108) coupled to the micro motor (106) to schedule the movement of the hour hand (102) and the minute hand (104). The energy saving time display device (100) further includes a time observance unit (110) configured to keep track of the current time and connected to the scheduler (108). The energy saving time display device (100) also includes an actuator (112) coupled to the micro motor (106) to actuate the micro motor (106) from a first state to a second state. In an embodiment of the present invention, the first state is a sleep mode and the second state is an activated mode. In the sleep mode, the energy saving time display device (100) is not displaying the time, where as in the activated mode the energy saving time display device (100) displays the current time. In an embodiment of the present invention, the micro motor (106) is capable activating plurality of states, but not limited to first state, second state etc. In another embodiment of the present invention, the user may set the duration of first state and second state.

According to another embodiment of the present invention, the hour hand (102) and the minute hand (104) of the energy saving time display device (100) is coupled to a gear mechanism. Typically, the gear mechanism is configured to drive the hour hand and the minute hand to represent the time. According to yet another embodiment of the present invention, the micro motor may be bidirectional or unidirectional. In one another embodiment of the present invention, the hour and minute hand may be driven with at least one micro motor, and the gear mechanism.

According to another embodiment of the present invention, the energy saving time display device (100) comprises at least two micro motors for driving the hour hand (102) and the minute hand (104) respectively to represent the time. In yet another embodiment of the present invention, the energy saving time display device (100) includes a second hand in addition to the hour hand and the minute hand. In yet another embodiment, of the present invention, the energy saving time display device (100) may include only one micro motor to drive the three hands that is the hour hand (102), the minute hand (104) and the second hand with the help of proper gear arrangement. In another embodiment of the present invention, the energy saving time display device (100) may include three micro motors to drive the three hands that is the hour hand (102), the minute hand (104) and the second hand (not shown). In one embodiment of the present invention, each of the micro motor drives one particular hand. In an embodiment of the present invention, the energy saving time display device further includes a time display unit and a time processing unit. The time display unit may comprise hour hand, minute hand and second hand. In yet another embodiment, the time display unit may comprise only the hour hand and the minute hand. The time processing unit comprises at least one micro motor, a scheduler, a time observance unit and an actuator. In one embodiment of the present invention, the time display unit and the time processing unit are coupled by either a mechanical circuitry, an electrical circuitry or combination thereof to perform the functionalities of the energy saving time display device.

According to an embodiment of the present invention, the time observance unit (110) comprises a real-time clock to keep track of the current time. The real-time clock helps in maintaining the schedules of the scheduler (108). The real-time clock of the time observance unit (110) provides the current time to the scheduler (108) in order to drive the micro motors to characterize the current time when needed. In yet another embodiment, the user is provided with the ability to schedule the first state and second state or a sequence of first state and second state.

According to another embodiment of the present invention, the energy saving time display device (100) includes a chronograph function. The chronograph function may be triggered by an actuator. The actuation mechanism includes but not limited to button, lever etc.

In one embodiment of the present invention, the energy saving time display device (100) is at least one of a motorized clock, timepiece or a wristwatch or a smart watch. In another embodiment of the present invention, the time display wristwatch is an analog wristwatch.

According to an exemplary embodiment of the present invention, the energy saving time display device (100) includes a first micro motor and a second micro motor. The first micro motor drives the hour hand and the second micro motor drives the minute hand or vice versa wherein the first micro motor drives the minute hand and the second micro motor drives the hour hand. In one embodiment for the present invention, the first micro motor and the second micro motors are configured to rotate in either direction. In another embodiment of the present invention, the micro motors are coupled to the scheduler by a resistor circuit and a capacitor circuit, wherein the resistor circuit and the capacitor circuit provides the right voltage to the motor. In yet another embodiment of the present invention, the scheduler may be a micro-controller. The values of the resistor circuit and the capacitor circuit employed depend on specifications of the micro motor. In an example embodiment of the present invention, the scheduler is driven by the battery. Generally, the battery can be rechargeable or non-rechargeable in nature.

The working of the energy saving time display device in accordance with an embodiment of the present invention is described as follows. The micro motor provides separate pins to control the direction of rotation. The micro motor rotates by “x” degrees for every pulse. The scheduler keeps the time using Real Time Clock Integrated Circuit, which is inbuilt. During general working of the energy saving time display device (100), for every second, the scheduler generates enough pulses for the second hand to move by 6 degrees, minute hand to move by 0.1 degrees and hour hand to move by 0.0041666 degrees. Based on the granularity of the rotation supported by the micro-motor, the minute and hour hands could move after completion of n1 and n2 seconds respectively.

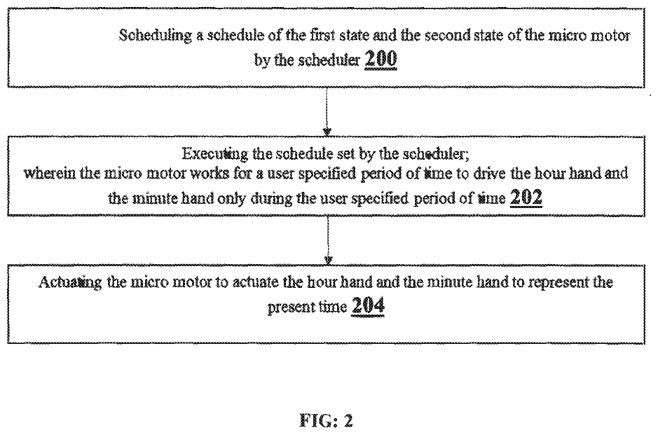

FIG. 2: illustrates the flow chart for the method for energy conservation of an energy saving time display device, in accordance with an embodiment of the present invention. The method for energy conservation of an energy saving time display device, wherein the energy saving time display device comprises an hour hand and a minute hand for indicating the time, at least one micro motor for driving the hour hand and the minute hand to characterize the time, a scheduler coupled to the micro motor to schedule the movement of the hour hand and the minute hand, a time observance unit configured to keep track of the current time, and an actuator coupled to the micro motor to actuate the micro motor from a first state to a second state. The method includes a step (200) of scheduling a schedule of the first state and the second state of the micro motor by the scheduler and the method includes a step (202) of executing the schedule set by the scheduler. The micro motor works for a user specified period of time to drive the hour hand and the minute hand. In yet another embodiment of the present invention, the method also includes the step (204) of actuating the micro motor to actuate the hour hand and the minute hand to represent the current time.

According to an embodiment of the method for energy conservation of an energy saving time display device, the step of scheduling of the schedule of the first state and the second state may include a plurality of schedules such that the micro motor is capable of activating plurality of states, but not limited to first state, second state etc. In another embodiment, the user may set the duration of first state and second state. Here, the micro motor works for a user specified period of time to drive the hour hand and the minute hand. In yet another embodiment of the present invention, the method further includes the step of actuating the micro motor to actuate the hour hand and the minute hand to represent the current time according to the schedule. In yet another embodiment of the present invention, in addition to the hour hand and the minute hand, the energy conserving time display device includes a second hand which operates according to the schedule.

According to an exemplary embodiment, the present invention facilitates the optimization of power consumed in an energy saving time display device. In order to optimize the power consumption, the scheduler may schedule the first state to the sleeping mode and the second to the activated mode. The scheduler schedules the energy saving time display device in the first state (sleep mode) in which the energy saving time display devices stop the movement of the hour hand and the minute hand from 22:00 to 6:00 (night to the morning) to reduce power consumed by the energy saving time display device. This saves the 8 hours of working of the energy saving time display device by stopping the rotation of the hour hand and the minute hand during the nighttime at which the user usually sleeps and hardly uses the energy saving time display device. The time observance unit with the help of the real-time clock keeps track of the time and the scheduler helps in activating the energy saving time display device to the second state from the first state and vice versa. At any point of time, when the energy saving time display device is in first state (sleep mode) the user is provided with the actuator to actuate the micro motor to characterize the current time by driving the second hand, minute hand and the hour hand to the respective position. In an embodiment, the actuator actuates the micro motor to characterize the current time by driving only minute hand and the hour hand to the respective position. After displaying the current time, the energy saving time display device returns to the first state i.e. the energy saving time display device stops moving the minute hand and the hour hand. Thus, by automatically switching off working of the energy saving time display device during sleep time (assumed 22:00 to 06:00) and there is 33.33% decrease in battery usage. In an embodiment, the sleep time may be manually set by the user. In another embodiment, the sleep time is automatically determined by the scheduler based on the activity of the user.

According to another embodiment of the present invention, the energy saving time display device is configured to characterize time only when actuated by the user. In this scenario, the actuator is triggered by the user, when the user needs to know the time. When the actuator is actuated by the user, the scheduler instructs the micro motor to characterize the current time based on the information about the current time from the time observance unit. Here, the hands of the energy saving time display device is kept still and is driven only when the user actuates the actuator. In yet another embodiment of the present invention, the hands of the energy saving time display device is always kept at 12:00 clock or any other time specified by the user. Assuming that the user sees time 20 times a day, the increase in battery life is up to a theoretical maximum of 91.81%. If the user sees time 50 times a day, the increase in battery life is up to a theoretical maximum of 79.54%.

According to an embodiment of the present invention, the actuator may be a press button on the energy saving time display device, it may be a gesture-based actuator, or it may be any mechanical or electronic actuating mechanism.

Thus, the present invention overcomes the problems of the existing systems using an energy conserving time display device, which conserves the battery power largely for the user by reducing the power consumption of the energy saving time display device. This solution is used in motorized watches and clocks and leads to massive savings in power consumption and battery life. Different solutions and the way they are implemented could lead to savings of about 90% too. i.e. for example batteries that lasted 2 years in a watch could last more than three and half years by implementing the present invention.

The foregoing description of the preferred embodiment of the present invention has been presented for the purpose of illustration and description. It is not intended to be exhaustive or to limit the invention to the precise form disclosed. Furthermore, all examples recited herein are principally intended expressly to be only for pedagogical purposes to aid the reader in understanding the principles of the present subject matter and are to be construed as being without limitation to such specifically recited examples and conditions. Many modifications and variations are possible in light of the above teachings. It is intended that the scope of the present invention not be limited by this detailed description.

We claim:

1) An energy saving time display device (100) comprising:
an hour hand (102) and a minute hand (104) for indicating the time;
at least one micro motor (106) for driving the hour hand (102) and the minute hand (104) to characterise the time;
a scheduler (108) coupled to the micro motor (106) to schedule the movement of the hour hand (102) and the minute hand (104);
a time observance unit (110) configured to keep track of the current time; and
an actuator (112) coupled to the micro motor (106) to actuate the micro motor (106) from a first state to a second state

2) The energy saving time display device as in claim 1, wherein the hour hand (102) and the minute hand (104) are coupled to a gear mechanism, wherein the gear mechanism is configured to drive the hour hand (102) and the minute hand (104) to represent the time.

3) The energy saving time display device as in claim 1, wherein the energy saving time display device comprises at least two micro motors for driving the hour hand and the minute hand respectively to represent the time.

4) The energy saving time display device as in claim 1, wherein the time observance unit (110) comprises a real-time clock.

5) The energy saving time display device as in claim 1, wherein the energy saving time display device is at least one of a motorized clock, time piece or a wrist watch or a smart watch.

6) The energy saving time display device as in claim 5, wherein the wrist watch is an analog wrist watch.

7) A method for energy conservation of an energy saving time display device, wherein the energy saving time display device comprises an hour hand and a minute hand for indicating the time, at least one micro motor for driving the hour hand and the minute hand to characterise the time, a scheduler coupled to the micro motor to schedule the movement of the hour hand and the minute hand, a time observance unit configured to keep track of the current time, and an actuator coupled to the micro motor to actuate the micro motor from a first state to a second state, the method comprises the steps of:
scheduling a schedule of the first state and the second state of the micro motor by the scheduler; and
executing the schedule set by the scheduler;
and wherein the micro motor is configured to function for a user specified period of time to drive the hour hand and the minute hand.

8) The method as in claim 7, further includes the step of actuating the micro motor to actuate the hour hand and the minute hand to represent the current time.
